(19) United States
(12) Patent Application Publication
(10) Pub. No.: US 2025/0153516 A1
(43) Pub. Date: May 15, 2025

(54) RUN-FLAT DEVICE

(71) Applicant: HUTCHINSON, PARIS (FR)

(72) Inventors: Mathieu POREBA, CROUY EN THELLE (FR); Laura SOARES, DRANCY (FR)

(21) Appl. No.: 18/943,734

(22) Filed: Nov. 11, 2024

(30) Foreign Application Priority Data
Nov. 13, 2023 (FR) 2312408

(51) Int. Cl. B60C 17/04; B60B 21/12

(52) U.S. Cl. CPC B60C 17/041; B60B 21/12; B60C 17/047

(57) ABSTRACT

A run-flat device is disclosed. The run-flat device comprises: a ring configured to be mounted against a wheel rim of a vehicle, the ring comprising a slot extending across its width and a radially outer boss; sectors each comprising a groove configured to cooperate with the boss, a first lateral edge having an angular extent defining that of the sector, and a second lateral edge having an angular extent less than that of the first edge, so that, with the sectors mounted on the ring, the second lateral edges define openings; an elastic band configured to be mounted around the sectors; and locking means, each configured to be inserted into one of the openings to hold the sectors together, and comprising a lateral flange extending from the second lateral edge.

### CROSS-REFERENCE TO RELATED APPLICATION(S)

This present application claims priority to French Patent Application No. 2312408, filed Nov. 13, 2023, the disclosure of which is hereby incorporated by reference in its entirety.

### TECHNICAL FIELD

The present disclosure relates to a run-flat device configured to be mounted around a wheel rim of a vehicle, and to a method for installing this device.

### BACKGROUND

The run-flat devices are well known in the art and have already been used in a variety of civilian and military applications. The aim of such a device is to allow the vehicle to continue running in the event of a tire failure on a wheel on which it is mounted. The tire failure may be due to bursting or deflation, for example. The run device then allows the vehicle to continue running for a certain distance so that it may be repaired or made safe.

The document CN-A-102673321 describes an example of a run-flat device comprising an inner ring mounted around a rim and to which sectors and an elastic band are jointly attached.

The document US-A1-2006/0219345 describes another example of a run-flat device comprising an elastic band made of a single piece mounted around sectors.

However, these run-flat devices may have disadvantages, in particular difficulties in installing them around a rim or difficulties in mounting the elastic band around the sectors. Another disadvantage may be that each part of the run-flat device is designed for a given type of rim and may not therefore be used on a different type of rim, for example with a larger diameter. A given run-flat device is then specific to a given type of rim.

A further objective of the disclosure is to propose a run-flat device that does not have at least one of the aforementioned disadvantages.

One aim of the disclosure is therefore to propose a run-flat device that is easy to mount.

### SUMMARY

It is thus proposed a run-flat device configured to be mounted around a one-part wheel rim of a vehicle, the device comprising: an inner ring comprising a radially inner face configured to be mounted against the one-part rim, a radially outer face, a first lateral face and a second lateral face, both connecting the radially inner face to the radially outer face, the inner ring further comprising: a slot extending across the width of the inner ring between the first lateral face and the second lateral face, an annular boss arranged on the radially outer face, and at least one wedging foot configured to rest against the rim; at least two sectors, each sector being equipped with a radially inner periphery and a radially outer periphery, and comprising: a groove arranged on the radially inner periphery to cooperate with the annular boss of the inner ring, a first lateral edge flaring radially outwards from the radially outer periphery and having a circumferential angular extent defining that of the sector, and a second lateral edge flaring radially outwards from the radially outer periphery and having a circumferential angular extent less than the circumferential angular extent of the first lateral edge, so that when the sectors are mounted on the inner ring, the second lateral edges of the sectors define openings; a one-part elastic band configured to be mounted against the radially outer periphery of the sectors; at least two locking means, each being configured to be inserted into one of the openings to hold the sectors together, each locking means comprising a lateral flange configured to come into the circumferential extension of the second lateral edge of each sector.

In this way, the disclosure simplifies the installation of the run-flat device, with a minimum number of elements that need to be mounted and that interact easily with each other. The slot in the inner ring allows it to open radially so that it may be installed around a one-part rim, without being impeded by the edges of the rim, whose respective diameters are generally greater than the diameter of the central portion of the rim around which the device is configured to be installed. In addition, the sectors are guided by the annular boss of the inner ring so that they may be easily mounted and centered on the ring. The different dimensions of the respective angular extents of the first and second lateral edges of the sectors allow to define openings that may be used as grips for installing the elastic band around the sectors, thus facilitating its assembly. In addition, the locking means, and in particular their lateral flanges, help to reinforce the axial blocking of the elastic band between the first and second lateral edges of the sectors, and also help, in use, to prevent the elastic band from disengaging from the radially outer periphery of the sectors.

The device according to the disclosure may comprise one or more of the characteristics below, taken alone with each other or in combination with each other: the openings defined by the second lateral edges of the sectors are diametrically opposed, the inner ring and/or each sector and/or each locking means are made of plastic, composite or metallic material, each of the sectors comprises at least one axial recess formed in the first lateral edge and/or in the second lateral edge, each lateral flange of the locking means has a circumferential angular extent substantially equal to the circumferential angular extent of the second lateral edge of a sector, each sector comprises a first end and a second end, these ends comprising cooperation means, the cooperation means are mechanical or magnetic.

The disclosure also relates to a wheel for a vehicle comprising a one-part rim and a run-flat device as described above, the device being mounted in a tire around the one-part rim.

The disclosure also relates to a method for installing a run-flat device as described above, the method comprising the following steps: installing the inner ring around the rim so that the wedging foot or feet rest against the rim; mounting each of the sectors on the inner ring by inserting the annular boss into the groove of the sectors so that, once the sectors are mounted on the inner ring, the second lateral edges of the sectors define openings; installing the one-part elastic band against the radially outer periphery of the sectors; and inserting each of the locking means into one of the openings and securing each locking means so as to hold the sectors together.

### BRIEF DESCRIPTION OF THE FIGURES

The disclosure will be better understood with the aid of the following description, given only by way of example and made with reference to the attached drawings wherein:

FIG. 1 shows a schematic exploded view of the run-flat device according to the disclosure,

FIG. 2 shows a schematic perspective view of the inner ring shown in FIG. 1,

FIG. 3 shows a schematic perspective view of a sector in FIG. 1,

FIG. 4 shows a schematic perspective view of an assembly of two sectors and a locking means, not mounted on the inner ring,

FIG. 5 shows a very schematic view of FIG. 4, in particular to illustrate the angular extent of the sectors, the first and second lateral edges and the locking means,

FIGS. 6A, 6B, and 6C show very schematic views of different configurations for the inner ring, mounted on different one-part rims,

FIG. 7 shows a schematic view of a wheel of a vehicle equipped with the run-flat device according to the disclosure,

FIG. 8 shows a schematic cross-section of the wheel in FIG. 7.

### DETAILED DESCRIPTION

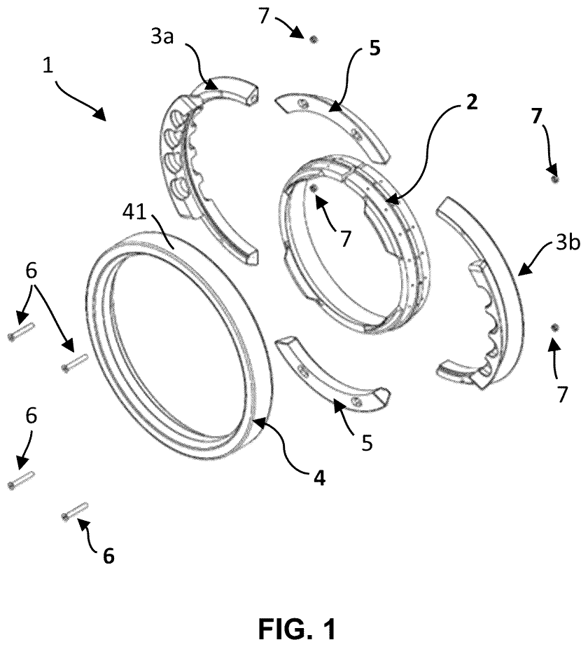

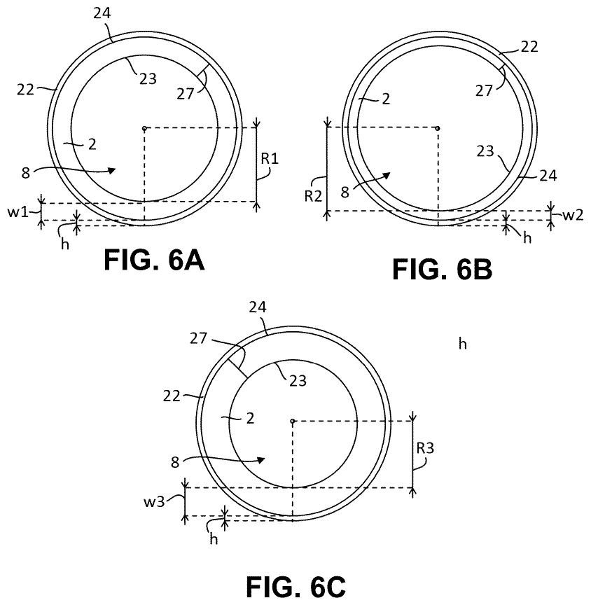

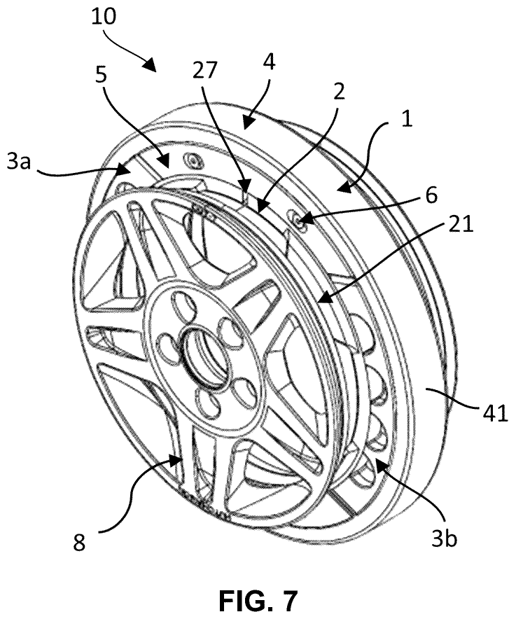

FIG. 1 shows a schematic diagram of a run-flat device 1 wherein at least some of the various parts are separate from one another. This run-flat device 1 thus comprises an inner ring 2, at least two sectors 3a, 3b, an elastic band 4, at least two locking means 5 and attachment elements such as screws 6 and nuts 7. The run-flat device 1 is also configured to be mounted around a one-part rim 8 of a tire 9 of a vehicle, which is illustrated in FIGS. 6A, 6B, 6C, and 7.

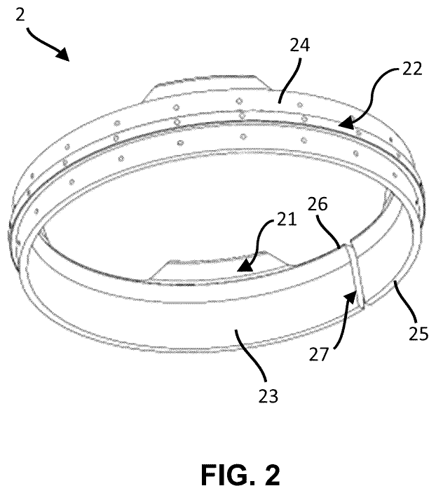

With reference to FIG. 2, the inner ring 2 of the run-flat device 1 comprises a radially inner face 23 configured to be mounted against the one-part rim 8, a radially outer face 24, a first lateral face 25 and a second lateral face 26. The first and second lateral faces 25, 26 both join the radially inner face 23 to the radially outer face 24.

The inner ring 2 also comprises a slot 27 extending across the width of the inner ring 2 between the first lateral face 25 and the second lateral face 26.

The inner ring 2 also comprises an annular boss 22 arranged on the radially outer face 24. The annular boss 22 may extend around the entire circumference of the radially outer face 24 or over predetermined portions of the radially outer face 24.

The inner ring 2 also comprises at least one wedging foot 21 configured to rest against the one- part rim 8. The inner ring 2 may comprise a single wedging foot 21 which extends axially outwards from the first lateral face 25 and/or from the second lateral face 26. It is understood that this single wedging foot 21 is circular.

The inner ring 2 may comprise a plurality of wedging feet 21 configured to bear against the one-part rim 8. The wedging feet 21 may extend axially outwards from the first lateral face 25 and/or from the second lateral face 26. The plurality of wedging feet 21 may be distributed circumferentially over the first lateral face 25 and/or the second lateral face 26. It is understood that the wedging feet 21 may be distributed over only one of the lateral faces 25, 26. For example, in FIG. 2, the wedging feet 21 all extend from the second lateral face 26. A plurality of wedging feet 21 has the advantage of making the run-flat device 1 lighter than a single circular wedging foot.

The wedging feet 21 may be distributed alternately, i.e. one wedging foot may extend from the first lateral face 25 and another may extend from the second lateral face 26.

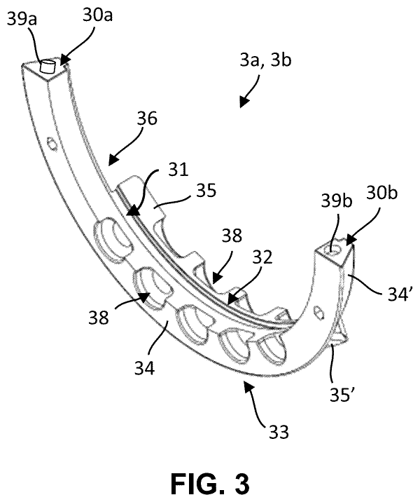

The run-flat device 1 comprises at least two sectors 3a, 3b. An example of sector 3a, 3b is shown in FIG. 3. Each sector 3a, 3b is equipped with a radially inner periphery 32 and a radially outer periphery 33.

Each sector 3a, 3b also comprises a groove 31 arranged on the radially inner periphery 32. This groove 31 is configured to cooperate with the annular boss 22 of the inner ring 2.

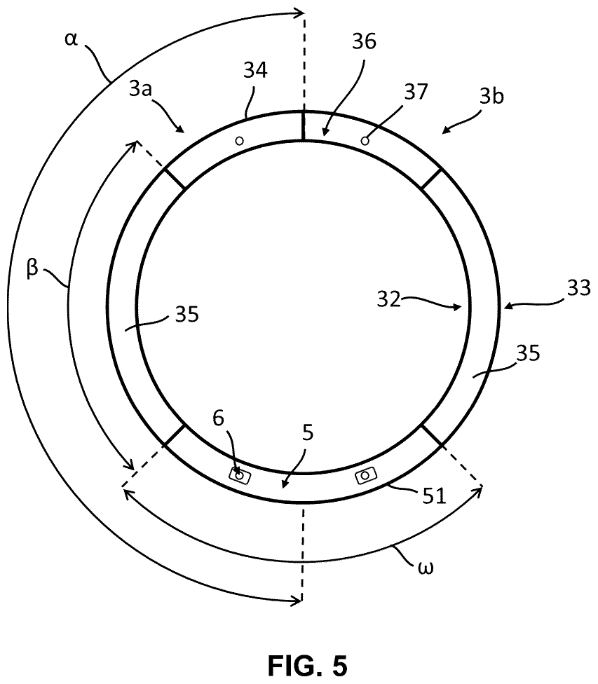

Each sector 3a, 3b also comprises a first lateral edge 34 which flares radially outwards from the radially outer periphery 33. This first lateral edge 34 has a circumferential angular extent a defining that of the sector 3a, 3b. In other words, the angular extent of a sector 3a, 3b is identical to the angular extent of the first lateral edge 34. Each sector 3a, 3b also comprises a second lateral edge 35 which flares radially outwards from the radially outer periphery 33. This second lateral edge 35 has a circumferential angular extent B that is less than the circumferential angular extent a of the first lateral edge 34, as shown in FIG. 5. In this way, once the sectors 3a, 3b are mounted on the inner ring, the second lateral edges 35 of the sectors 3a, 3b define openings 36.

Each sector 3a, 3b has a first end 30a and a second end 30b. The first end 30a of a first sector 3a is configured to cooperate with the second end 30b of a second sector 3b. It is understood that, in the case where the run-flat device I comprises two sectors 3a, 3b, the second end 30b of the first sector 3a is configured to cooperate with the first end 30a of the second sector 3b.

Advantageously, each sector 3a, 3b comprises cooperation means 39a, 39b at each of its ends 30a, 30b, a first cooperation means 39a of a first end 30a of a given first sector 3a being configured to cooperate with a second cooperation means 39b of a second end 30b of a second sector 3b. These cooperation means 39a, 39b may take the form of a tenon 39a and a mortise 39b, the tenon 39a of a given sector 3a being configured to cooperate with the mortise 39b of another sector 3b. It is understood that there is a mechanical assembly of the sectors 3a, 3b. Alternatively, the cooperation means 39a, 39b may take the form of magnets. It is understood that there is a magnetic assembly of the sectors 3a, 3b.

These cooperation means 39a, 39b at the ends 30a, 30b of each sector 3a, 3b allow the sectors 3a, 3b to be held together on the inner ring 2 pending receipt of an elastic band 4 as detailed below. Advantageously, the sectors 3a, 3b are rigid.

Advantageously, the sectors 3a, 3b are identical. This makes them easy to interchange by replacing a worn sector with another without any compatibility problems with the other parts. This also facilitates their production while reducing costs.

Advantageously, each of the sectors 3a, 3b comprises at least one axial recess 38 formed in the first lateral edge 34 and/or in the second lateral edge 35. Each recess 38 may be blind or through-going. Each axial recess 38 may have a generally cylindrical shape. This axial recess 38 allows to reduce the weight of the sector 3a, 3b without adversely affecting the mechanical properties, in particular the compressive strength, of the sector 3a, 3b.

The first lateral edge 34 may have a first frustoconical surface 34′ extending radially outwards from the radially outer periphery 33. The second lateral edge 35 may have a second frustoconical surface 35′ extending radially outwards from the radially outer periphery 33.

The run-flat device I also comprises a one-part elastic band 4. A one-part is a continuous part. Preferably, the elastic band 4 is not split across its width. It is understood that the elastic band 4 takes the form of a closed ring. The elastic band 4 is configured to be mounted against the radially outer periphery 33 of the sectors 3a, 3b.

In particular, the elastic band 4 has a tread 41 configured to be in contact with the ground or the deflated/flattened tire when the wheel on which the run-flat device 1 is installed fails. The elastic band 4 may be made of elastomer material.

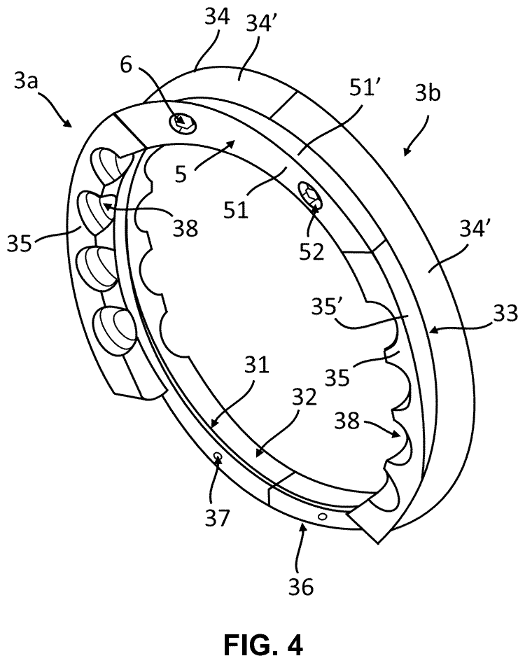

The run-flat device 1 comprises at least two locking means 5. Each of these locking means 5 is configured to be inserted into one of the openings 36 to hold the sectors 3a, 3b together. Each locking means 5 comprises a lateral flange 51 configured to extend circumferentially from the second lateral edge 35 of each sector 3a, 3b. This aspect is detailed below in FIGS. 4 and 5. It is also understood that the lateral flange 51, when the locking means 5 is inserted into the opening 36, flares radially outwards from the radially outer periphery 33 of the sectors 3a, 3b.

Each locking means 5 is attached to the sectors 3a, 3b, in one of the openings 36, by at least two screws 6 each held by a nut 7. Each screw 6 is inserted through a passage 52 in the locking means 5 and an orifice 37 provided in the first lateral edge 34 of a sector 3a, 3b. For given screws 6, a locking means 5 is common but not the sectors 3a, 3b. In other words, a first screw/nut assembly 6, 7 connects the locking means 5 to a first sector 3a, while a second screw/nut assembly 6, 7 connects the locking means 5 to a second sector 3b.

The lateral flange 51 of each locking means 5 may have a frustoconical surface 51′ which extends radially outwards. This frustoconical surface 51′is configured to extend in line with the second frustoconical surface 35′ of the second lateral edges 35 of the sectors 3a, 3b.

FIGS. 4 and 5 show the assembly of two sectors 3a, 3b, as it might be on an inner ring 2. For illustration purposes, the inner ring 2 is not shown. The assembly is also completed by a locking means 5 in one of the openings 36.

When the sectors 3a, 3b are assembled, the first lateral edge 34 of the sector 3a is in circumferential alignment with the first lateral edge 34 of the sector 3b. It is understood that the same applies to the first frustoconical surface 34′ of each first lateral edge 34, where applicable.

As the second lateral edge 35 has a circumferential angular extent β less than the circumferential angular extent a of the first lateral edge 34, openings 36 are defined between each of the second lateral edges 35 of the sectors 3a, 3b. Advantageously, the openings 36 are defined so that they are diametrically opposed to one another. It is understood that the second lateral edges 35 and the locking means 5 are also diametrically opposed. In use, this allows to ensure that the run-flat device 1 is well balanced and avoids unbalance.

When one of the locking means 5 is inserted into one of the openings 36 to hold the sectors 3a, 3b together, the lateral flange 51 of the locking means 5 comes into circumferential alignment with each of the second lateral edges 35 of the sectors 3a, 3b that the locking means holds together. It is understood that the same applies to the frustoconical surface 51′ of the lateral flange 51 with the second frustoconical surfaces 35′ of the second lateral edges 35, where applicable.

With reference to FIG. 5, the first lateral edge 34 has a circumferential angular extent α that is at most 180° (degrees). The second lateral edge 35 has a circumferential angular extent β that is less than the circumferential angular extent α of the first lateral edge 34. The circumferential angular extent B of the second lateral edge 35 may be between 30° and 150°. In the example shown in FIG. 5, the circumferential angular extent β of the second lateral edge 35 is substantially equal to 120°.

The lateral flange 51 of each locking means 5 may have a circumferential angular extent ω substantially equal to the circumferential angular extent β of the second lateral edge 35 of a sector 3a, 3b. It is understood that in such a case, for reasons of geometric limitations, the circumferential angular extent ω of the lateral flange 51 is substantially equal to the circumferential extent of the second lateral edge 35 without being greater than the latter. In such a case, the circumferential angular extent ω of the lateral flange 51 is at most 120°.

The circumferential angular extent @ of the lateral flange 51 may, in addition, be less than or greater than the circumferential angular extent β of the second lateral edges 35.

We now turn to FIGS. 6A, 6B, and 6C wherein the radius of the one-part rim 8 varies. For example, in the case A, the radius of the rim 8 is R1, in the case B, the radius of the rim 8 is R2 and in the case C, the radius of the rim 8 is R3, so that R3<R1<R2.

The annular boss 22 which extends on the radially outer face 24 of the inner ring 2 has a predefined height h which extends radially from the radially outer face 24. As the annular boss 22 is designed to cooperate with the groove 31 of the sectors 3a, 3b, it is understood that the predefined height h of the annular boss 22 is substantially equal to the radial dimensions of the groove 31 of the sectors 3a, 3b. This height h is intended to be fixed. By fixed, we mean that the variation in dimension is small, or even negligible.

As the height h of the annular boss 22 is fixed, the inner ring 2 has a thickness that may vary in order to compensate for the variation in the radius, and therefore the diameter, of the rims 8. In practice, the radius of a one-part rim 8 may change from one model to another. It is therefore advantageous to have an adaptable inner ring 2 without having to make any geometric modifications to the sectors 3a, 3b and locking means 5. More precisely, it is the radial dimension w1, w2, w3 which separates the radially inner face 23 from the radially outer face 24 which may then vary. It is understood that in the case A with a one-part rim 8 of radius R1, the inner ring 2 has a radial dimension w1; in the case B with a one-part rim 8 of radius R2, the inner ring 2 has a radial dimension w2; and in case C with a one-part rim 8 of radius R3, the inner ring 2 has a radial dimension w3, so that w3>w1>w2 since R3<R1<R2. It is understood that the radial dimension w1, w2, w3 varies inversely with the radius R1, R2, R3 of the rim.

It is understood that the radius R1, R2, R3 of the rim 8 is equivalent to the radius of the radially inner face 23 of the inner ring 2.

It is understood that the inner ring 2 may be modified to adapt to different one-part rims 8 without modifying the other elements of the run-flat device 1, such as the sectors 3a, 3b, the elastic band 4 or the locking means 5. In particular, the radial dimension separating the radially inner face 23 from the radially outer face 24 may be varied.

This has the advantage of facilitating the installation of the run-flat device 1, as only the inner ring needs to be adapted to the one-part rim 8. This also represents a gain in efficiency for operators, who do not have to search for the correct product reference for the sectors 3a, 3b, locking means 5 and clastic band 4, which are then standard for all types of rim 8.

In the disclosure, the inner ring 2 and/or each sector 3a, 3b and/or each locking means 5 may be made of plastic, composite or metal. It is understood that the inner ring 2, each sector 3a, 3b and each locking means 5 may all be made from the same material. It is also understood that among the inner ring 2, each sector 3a, 3b and each locking means 5, at least one of the aforementioned elements may be made of a different material to the other elements.

It is understood that the run-flat device I may be in the form of a kit wherein each element or a portion of the elements of the run-flat device 1 is separate from the other elements.

The kit may thus comprise an inner ring 2, at least two sectors 3a, 3b, an elastic band 4 made in one-part, at least two locking means 5 and at least four fastening elements such as screws 6 and nuts 7, each of the aforementioned elements being as described above.

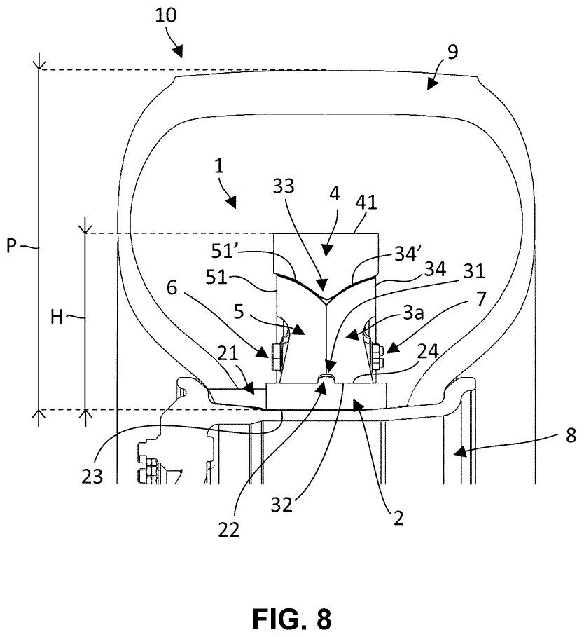

With reference to FIGS. 7 and 8, the disclosure also relates to a wheel 10 of a vehicle, this wheel 10 comprising a one-part rim 8 and a run-flat device 1 as described above. The run-flat device 1 is also mounted in a tire 9 around the one-part rim 8.

Advantageously, within this wheel 10, the run-flat device 1 is designed so that a ratio between the height H of the run-flat device 1, defined radially, and the height P of the tire 9, defined radially between the one-part rim 8 and the outer face of the tire in a nominal operating state, i.e. inflated, is between 0.4 and 0.6, and preferably between 0.45 and 0.55. This is an optimum to facilitate the mounting of the device 1 on the one-part rim 8 without weakening it in use.

The disclosure also relates to a method for installing, around a one-part rim 8, a run-flat device 1 as described above. This method comprises the following steps: installing the inner ring 2 around the one-part rim 8 so that the wedging foot or feet 21 rest against the rim 8; mounting each of the sectors 3a, 3b on the inner ring 2 by inserting the annular boss 22 into the groove 31 of the sectors 3a, 3b so that, once the sectors 3a, 3b are mounted on the inner ring 2, the second lateral edges 35 of the sectors 3a, 3b define openings 36; installing the elastic band 4 made in a single piece against the radially outer periphery 33 of the sectors 3a, 3b; and inserting each of the locking means 5 into one of the openings 36 and securing each locking means 5 so as to hold the sectors 3a, 3b together.

In step a), the inner ring 2 which is split may be radially deformed so that its diameter is greater than its initial diameter. Thanks to this deformation, the inner ring 2 may more easily pass one of the rim flanges, which generally have diameters greater than the diameter of the central portion of the rim 8. The inner ring 2 is also configured so that, if necessary, it may return to its original shape after being deformed.

Still in step a), the wedging foot or feet 21 may be placed against a rim flange as shown in FIG. 8.

In step c), to facilitate the installation of the one-part elastic band 4, it may be passed through the openings 36 to be mounted against the radially outer periphery 33 of the sectors 3a, 3b. The openings 36 ensure a better grip for the elastic band 4.

In step d), once the elastic band 4 has been mounted against the radially outer periphery 33, it is blocked axially between the first and second lateral edges 34, 35 of the sectors 3a, 3b. The locking means 5 inserted in the openings 36 then reinforce the axial blocking of the elastic band 4. In use, the locking means 5 allow to prevent the elastic band 4 from disengaging through the openings 36 in the radially outer periphery 33.

In step d), the locking means 5 may be secured to the sectors 3a, 3b using fastening elements such as screws 6 and nuts 7.

In the light of the above, it is understood that the run-flat device 1 has the advantage of simplifying the installation of the run-flat device with a minimum of elements to be mounted, while allowing these different elements to cooperate easily with each other. The slot in the inner ring allows it to open radially so that it may be installed around a one-part rim, without being impeded by the edges of the rim, whose respective diameters are generally greater than the diameter of the central portion of the rim around which the device is configured to be installed. In addition, the sectors are guided by the annular boss of the inner ring so that they may be easily mounted and centered on the ring. The different dimensions of the respective angular extents of the first and second lateral edges of the sectors allow to define openings that may be used as grips for installing the elastic band around the sectors, thus facilitating its assembly. In addition, the locking means, and in particular their lateral flanges, help to reinforce the axial blocking of the elastic band between the first and second lateral edges of the sectors, and also help, in use, to prevent the elastic band from disengaging from the radially outer periphery of the sectors.

1. A run-flat device configured to be mounted around a one-part wheel rim of a vehicle, the run- flat device comprising:
an inner ring comprising a radially inner face configured to be mounted against the one-part wheel rim, a radially outer face, a first lateral face and a second lateral face, both connecting the radially inner face to the radially outer face, the inner ring comprising:
a slot extending across a width of the inner ring between the first lateral face and the second lateral face,
an annular boss arranged on the radially outer face, and
at least one wedging foot configured to rest against the one-part wheel rim;
at least two sectors, each sector being equipped with a radially inner periphery and a radially outer periphery, and comprising:
a groove arranged on the radially inner periphery to cooperate with the annular boss of the inner ring,
a first lateral edge flaring radially outwards from the radially outer periphery and having a circumferential angular extent (α) defining that of the sector, and
a second lateral edge flaring radially outwards from the radially outer periphery and having a circumferential angular extent (β) less than the circumferential angular extent (α) of the first lateral edge, so that once the at least two sectors are mounted on the inner ring, the second lateral edge of the at least two sectors define openings;
a one-part elastic band configured to be mounted against the radially outer periphery of the at least two sectors; and
at least two locking means, each configured to be inserted into one of the openings to hold the at least two sectors between them, each locking means comprising a lateral flange configured to come into a circumferential extension of the second lateral edge of each sector.

2. The run-flat device according to claim 1, wherein the openings defined by the second lateral edge of the at least two sectors are diametrically opposed.

3. The run-flat device according to claim 1, wherein the inner ring and/or each sector and/or each locking means are made of plastic, composite or metallic material.

4. The run-flat device according to claim 1, wherein each of the sectors comprises at least one axial recess formed in the first lateral edge and/or in the second lateral edge.

5. The run-flat device according to claim 1, wherein each lateral flange of the at least two locking means has a circumferential angular extent (ω) substantially equal to the circumferential angular extent (β) of the second lateral edge of a sector.

6. The run-flat device according to claim 1, wherein each sector comprises a first end and a second end, the first and second ends comprising cooperation means.

7. The run-flat device as claimed in claim 6, wherein the cooperation means are mechanical or magnetic.

8. A wheel for a vehicle, the wheel comprising:
a one-part rim; and
a run-flat device, the run-flat device comprising:
an inner ring comprising a radially inner face configured to be mounted against the one-part rim, a radially outer face, a first lateral face and a second lateral face, both connecting the radially inner face to the radially outer face, the inner ring comprising:
a slot extending across a width of the inner ring between the first lateral face and the second lateral face,
an annular boss arranged on the radially outer face, and
at least one wedging foot configured to rest against the one-part rim;
at least two sectors, each sector being equipped with a radially inner periphery and a radially outer periphery, and comprising:
a groove arranged on the radially inner periphery to cooperate with the annular boss of the inner ring,
a first lateral edge flaring radially outwards from the radially outer periphery and having a circumferential angular extent (α) defining that of the sector, and
a second lateral edge flaring radially outwards from the radially outer periphery and having a circumferential angular extent (β) less than the circumferential angular extent (α) of the first lateral edge, so that once the at least two sectors are mounted on the inner ring, the second lateral edge of the at least two sectors define openings;
a one-part elastic band configured to be mounted against the radially outer periphery of the at least two sectors; and
at least two locking means, each configured to be inserted into one of the openings to hold the at least two sectors between them, each locking means comprising a lateral flange configured to come into the circumferential extension of the second lateral edge of each sector,
the run-flat device being mounted in a tire around the one-part rim.

9. A method for installing a run-flat device around a one-part rim of a vehicle, the method comprising the following steps:
installing an inner ring around the one-part rim so that at least one wedging foot rests against the one-part rim;
mounting sectors on the inner ring by inserting an annular boss into a groove of the sectors so that, once the sectors are mounted on the inner ring, second lateral edges of the sectors define openings;
installing a one-part elastic band against radially outer periphery of the sectors; and
inserting each locking means into one of the openings and securing each of the locking means so as to hold the sectors together.

10. The method according to claim 9, wherein the run-flat device comprises:
the inner ring comprising a radially inner face configured to be mounted against a one-part wheel rim, a radially outer face, a first lateral face and a second lateral face, both connecting the radially inner face to the radially outer face, the inner ring comprising:
a slot extending across a width of the inner ring between the first lateral face and the second lateral face,
an annular boss arranged on the radially outer face, and
at least one wedging foot configured to rest against the one-part wheel rim;
at least two sectors, each sector being equipped with a radially inner periphery and a radially outer periphery, and comprising:
a groove arranged on the radially inner periphery to cooperate with the annular boss of the inner ring,
a first lateral edge flaring radially outwards from the radially outer periphery and having a circumferential angular extent (α) defining that of the sector, and
a second lateral edge flaring radially outwards from the radially outer periphery and having a circumferential angular extent (β) less than the circumferential angular extent (α) of the first lateral edge, so that once the at least two sectors are mounted on the inner ring, the second lateral edge of the at least two sectors define openings;
a one-part elastic band configured to be mounted against the radially outer periphery of the at least two sectors; and
at least two locking means, each configured to be inserted into one of the openings to hold the at least two sectors between them, each locking means comprising a lateral flange configured to come into a circumferential extension of the second lateral edge of each sector.
